(19) United States
(12) Patent Application Publication
(10) Pub. No.: US 2006/0278105 A1
(43) Pub. Date: Dec. 14, 2006

(54) Positioning device for printing device of printing apparatus for paperboards for making paper boxes

(76) Inventor: Chih-Chieh Hsiao, Taipei (TW)

Correspondence Address: PRO-TECHTOR INTERNATIONAL SERVICES, 20775 NORADA CT., SARATOGA, CA, 95070, US

(21) Appl. No.: 11/151,849

(22) Filed: Jun. 13, 2005

(51) Int. Cl. B41F 5/00

(52) U.S. Cl. 101/216

(57) ABSTRACT

A printing apparatus for paperboards includes two movable frame plates, a printing device mounted between the movable frame plates, two side frames each having an opening in an upper portion thereof to allow hoisting of the movable frame plates, and at least one positioning device mounted on each side frame. The at least one positioning device includes a pneumatic cylinder and a push mechanism actuatable by the pneumatic cylinder to a position pressing against each movable frame plate to thereby position the printing device.

### BACKGROUND OF THE INVENTION

1. Field of the Invention

The present invention relates to a positioning device for a printing device of a printing apparatus. In particular, the present invention relates to a positioning device for a printing device of a printing apparatus for paperboards for making paper boxes.

2. Description of the Related Art

Procedures such as feeding, printing, slotting, folding, stacking, and packaging are involved in a manufacturing line for an ordinary paper box, and associated equipment is used for automatic mass production.

In the printing procedure, paperboards are passed through a plurality of printing apparatuses to print letters, figures, drawings, etc of predetermined colors on the paperboards. A typical printing apparatus comprises a row of feeding rollers on a lower portion of each of two side frames thereof. A printing device is hoisted in an upper portion of the printing apparatus and comprises a printing cylinder and a pattern cylinder for carrying out printing on the paperboards fed by the feeding rollers.

The whole printing device is elevated upward when mounting or replacing a cylindrical printing plate on an outer circumference of the printing cylinder, and the printing device is lowered after mounting or replacement. Fixing bolts are turned to a position pressing against a lateral side of each of two frame plates of the printing device, thereby positioning the printing cylinder in the predetermined location.

However, the positioning effect provided by the fixing bolts is limited, and precise, reliable positioning could not be achieved. The printing cylinder is liable to wobble and shift during operation, adversely affecting the printing quality.

### SUMMARY OF THE INVENTION

A printing apparatus for paperboards in accordance with the present invention comprises two movable frame plates, a printing device mounted between the movable frame plates, two side frames each comprising an opening in an upper portion thereof to allow hoisting of the movable frame plates, and at least one positioning device mounted on each side frame. The at least one positioning device comprises a pneumatic cylinder and a push mechanism actuatable by the pneumatic cylinder to a position pressing against each movable frame plate to thereby position the printing device.

Preferably, two positioning devices are respectively mounted to an upper portion and a lower portion of each side frame.

Preferably, the push mechanism of the at least one positioning device comprises an axle rotatably extending through an associated side frame. An eccentric wheel and a rocker lever are fixed to the axle. The eccentric wheel includes a circumference pressing against a lateral side of an associated movable frame plate. The pneumatic cylinder comprises an end pivotally connected to an associated side frame. The pneumatic cylinder comprises a piston rod movable between a retracted position and an extended position. The rocker lever includes a free end pivotally connected to an end of the piston rod.

When each piston rod is in the extended position, the associated eccentric wheel is disengaged from the lateral edge of the associated side frame to allow mounting or replacement of a cylindrical printing plate of the printing cylinder. When each piston rod is moved to the retracted position, the associated eccentric wheel presses against the lateral edge of the associated side frame to position the printing device. A reliable positioning effect is provided for the printing cylinder of the printing device and a satisfactory printing effect is obtained.

Preferably, the eccentric wheel comprises a bearing mounted around a circumference thereof.

Preferably, each movable frame plate comprises an abutting member mounted thereto, and the circumference of the eccentric wheel presses against the abutting member.

Other objectives, advantages, and novel features of the invention will become more apparent from the following detailed description when taken in conjunction with the accompanying drawings.

### BRIEF DESCRIPTION OF THE DRAWINGS

FIG. 1 is a sectional view of a printing apparatus in accordance with the present invention.

FIG. 2 is a view from an inner side of the printing apparatus in accordance with the present invention, illustrating structure of a side of a printing device of the printing apparatus,

FIG. 3 is a view illustrating a positioning state of a pair of positioning devices on a side of the printing device in FIG. 2.

FIG. 4 is a sectional view similar to FIG. 3, illustrating a release state of the positioning devices.

FIG. 5 is a sectional view taken along plane 5-5 in FIG. 4.

FIG. 6 is a side view of the upper positioning device in FIG. 4.

### DETAILED DESCRIPTION OF THE PREFERRED EMBODIMENT

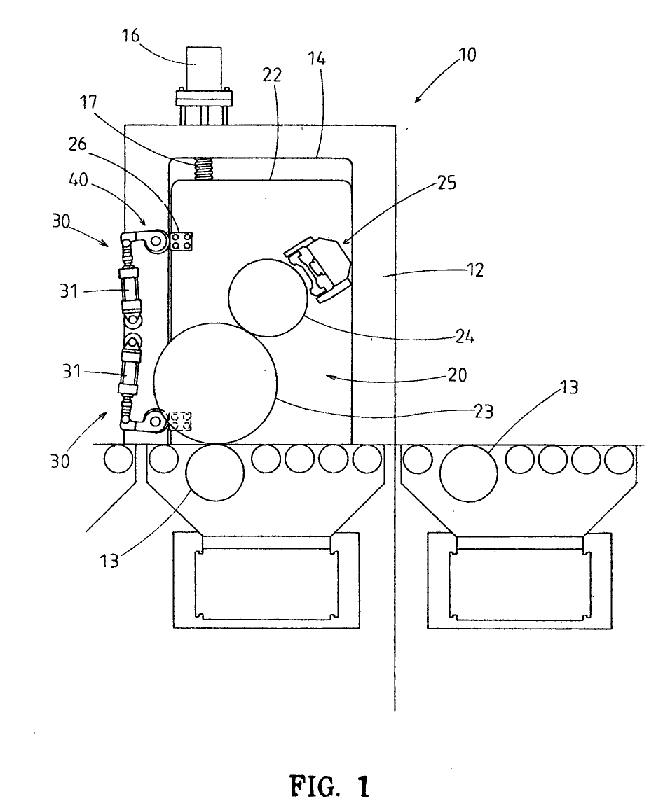

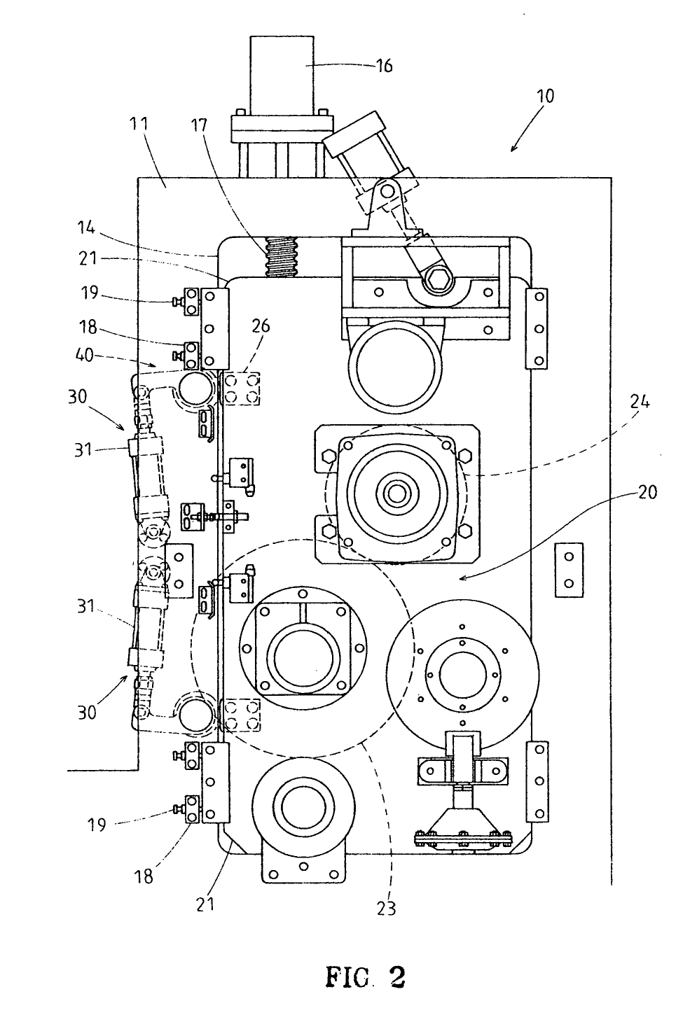

Referring to FIGS. 1 and 2, a printing apparatus in accordance with the present invention comprises two side frames 11 and 12 each having a row of air-suction type feeding rollers 13 mounted to a lower portion thereof An opening area 14 is provided on an upper portion of each side frame 11, 12 for hoisting an associated one of two movable frame plates 21 and 22 that accommodate a printing device 20.

The printing device 20 comprises a printing cylinder 23 mounted between the movable frame plates 21 and 22, a pattern cylinder 24 mounted between the movable frame plates 21 and 22, and a scraper device 25 mounted outside the movable frame plates 21 and 22.

Preferably, the opening areas 14 and the movable frame plates 21 and 22 are rectangular. Each opening area 14 has a height greater than that of the movable frame plate 21, 22 to provide a space allowing lifting and lowering. Each opening area 14 has a width slightly greater than that of the movable frame plate 21, 22.

A screw elevator 16 is mounted to each side frame 11, 12 and includes a screw rod 17 threadedly engaged with the associated movable frame plate 21, 22 for lifting or lowering the printing device 20. FIG. 2 shows the side frame 11 and the associated movable frame plate 21, whereas FIG. 1 shows the other side frame 12 and the associated movable frame plate 22.

Further, two sets of supports 18 and fixing bolts 19 (FIG. 2) are respectively mounted to upper and lower portions of a lateral side of each side frame 11, 12. The fixing bolts 19 can be turned to press against the lateral side of the movable frame plate 21, 22 to fix the movable frame plate 21, 22, thereby positioning the printing device 20.

As mentioned above, the positioning effect provided by the fixing bolts 19 are insufficient to reliably position the printing device 20 during operation. To solve this problem, at least one positioning device 30 is mounted on each side frame 11, 12 for fixing the associated movable frame plate 21, 22, thereby positioning the printing device 20. In the illustrated embodiment, a positioning device 30 is mounted to an upper portion of a front section of each side frame 11, 12, and another positioning device 30 is mounted to a lower portion of a front section of each side frame 11, 12.

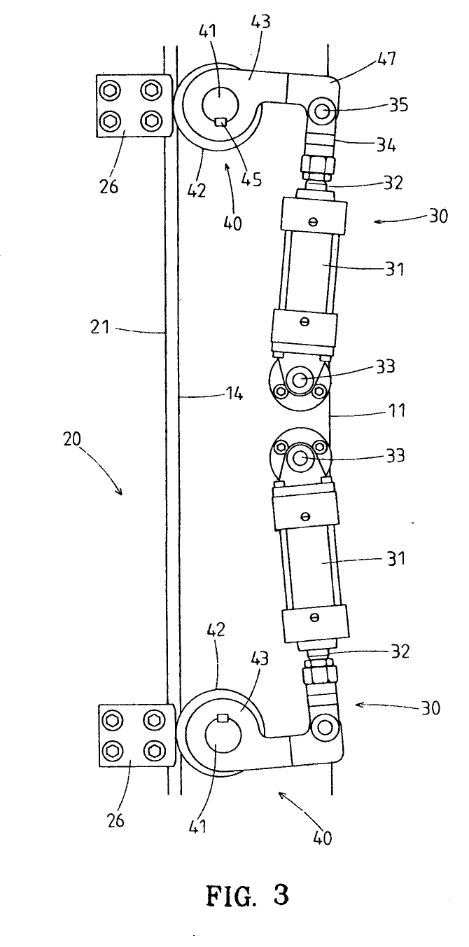

Referring to FIGS. 2 and 3, each positioning device 30 includes a pneumatic cylinder 31 and a push mechanism 40 that can be actuated by the pneumatic cylinder 31 to a position pressing against the lateral side of the movable side frame 21, 22. The printing device 20 and its printing cylinder 23 are thus fixed in place, avoiding wobbling and shifting of the printing cylinder 23 during operation and assuring printing quality on the paperboards for making paper boxes.

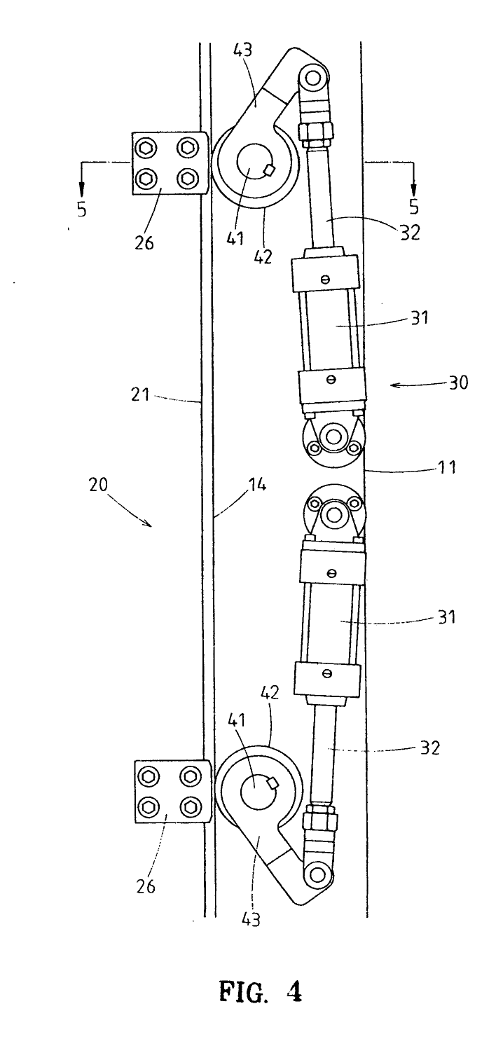

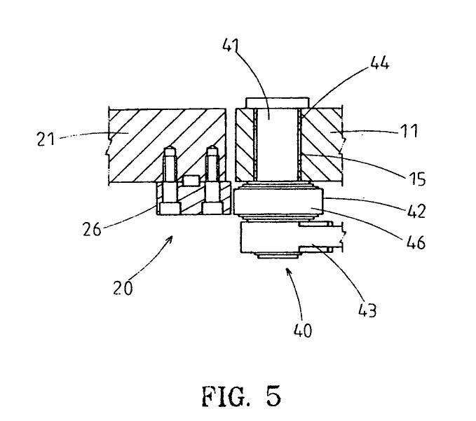

In the illustrated embodiment, the pneumatic cylinder 31 includes a piston rod 32 movable between a retracted position (FIG. 3) and an extended position (FIG. 4). The piston rod 32 includes an end on which a coupler 34 is mounted. The pneumatic cylinder 31 includes an end pivotally connected to a rod 33 fixed on the side frame 11, 12. The push mechanism 40 includes an axle 41 extending through an axle hole 15 (FIG. 5) of the side frame 11, 12. A jacket 44 is mounted around the axle 41 and located in the axle hole 15, allowing rotation of the axle 41. An end of the axle 41 extends out of the side frame 11, 12, with an eccentric wheel 42 and a rocker lever 43 being mounted in sequence on the exposed end of the axle 41. A key 45 is provided to fix the eccentric wheel 42 and the rocker lever 43. A pin 35 is provided to pivotally connect the coupler 34 to a free end 47 of the rocker lever 43.

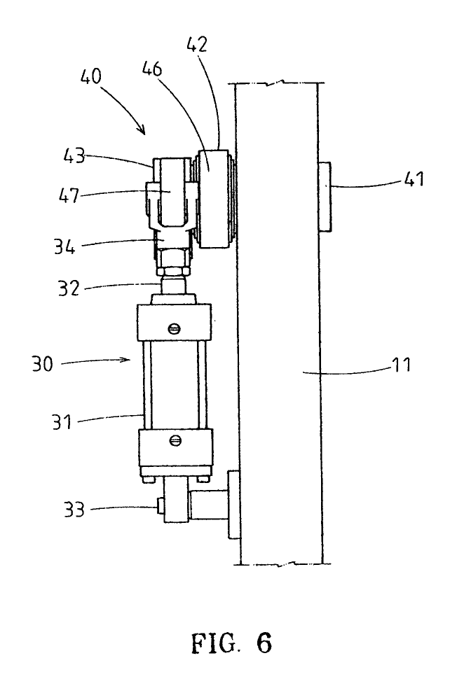

Two abutting members 26 are mounted on the side frame 21, 22 and each faces the associated eccentric wheel 42. The eccentric wheel 42 may include a bearing 46 (FIGS. 5 and 6) on a circumference thereof fore pressing against the abutting member 26.

The positioning devices 30 in FIG. 3 are in a positioning state in which each eccentric wheel 42 presses against the associated abutting member 26. It is noted that the piston rod 32 of each pneumatic cylinder 31 is in a retracted position.

When mounting or replacing of a cylindrical printing plate (not shown) mounted to a circumference of the printing cylinder 23 is required, each positioning device 30 is moved to a release state in which the piston rod 32 of each pneumatic cylinder 31 is moved to the extended position. The rocker lever 43 is moved to cause pivotal movement of the axle 41 and the eccentric wheel 42, thereby disengaging the eccentric wheel 42 from the abutting member 26 fixed on the side frame 21, 22, as shown in FIG. 4. The printing device 20 is no longer positioned.

After mounting or replacement, the piston rod 32 of each pneumatic cylinder 31 is moved to the retracted position. The rocker lever 43 is moved to cause pivotal movement of the axle 41 and the eccentric wheel 42, thereby moving the eccentric wheel 42 to a position pressing against the abutting member 26 fixed on the side frame 21, 22, as shown in FIG. 3. The printing device 20 is positioned again. It is noted that the fixing bolts 19 and the supports 18 can be omitted.

Although a specific embodiment has been illustrated and described, numerous modifications and variations are still possible without departing from the essence of the invention. The scope of the invention is limited by the accompanying claims.

What is claimed is:

1. A printing apparatus for paperboards, comprising:
two movable frame plates;
a printing device mounted between the movable frame plates;
two side frames each comprising an opening in an upper portion thereof to allow hoisting of the movable frame plates; and
at least one positioning device mounted on each said side frame, said at least one positioning device comprising a pneumatic cylinder and a push mechanism actuatable by the pneumatic cylinder to a position pressing against each said movable frame plate to thereby position the printing device.

2. The printing apparatus as claimed in claim 1, wherein the number of said at least one positioning device is two, said two positioning devices being respectively mounted to an upper portion and a lower portion of each said side frame.

3. The printing apparatus as claimed in claim 1, wherein the push mechanism of said at least one positioning device comprises an axle rotatably extending through an associated one of the side frames, an eccentric wheel and a rocker lever being fixed to the axle, the eccentric wheel including a circumference pressing against a lateral side of an associated one of the movable frame plates, the pneumatic cylinder comprising an end pivotally connected to an associated one of the side frames, the pneumatic cylinder comprising a piston rod movable between a retracted position and an extended position, the rocker lever including a free end pivotally connected to an end of the piston rod.

4. The printing apparatus as claimed in claim 3, wherein the eccentric wheel comprises a bearing mounted around a circumference thereof.
The printing apparatus as claimed in claim 3, wherein each said movable frame plate comprises an abutting member mounted thereto, and wherein the circumference of the eccentric wheel presses against the abutting member.
